(19) United States
(12) Patent Application Publication
(10) Pub. No.: US 2011/0105658 A1
(43) Pub. Date: May 5, 2011

(54) PHOSPHATE ESTER POLYMERIC MIXTURE CONTAINING INTERMEDIATE TRANSFER MEMBERS

(75) Inventor: Jin Wu, Pittsford, NY (US)

(73) Assignee: Xerox Corporation, Norwalk, CT (US)

(21) Appl. No.: 12/608,683

(22) Filed: Oct. 29, 2009

(51) Int. Cl. C08K 5/52; G03G 15/01

(52) U.S. Cl. 524/145; 399/302

(57) ABSTRACT

An intermediate transfer media, such as a belt, that includes a phosphate ester and a polymeric binder.

### CROSS REFERENCE TO RELATED APPLICATIONS

U.S. application No. (not yet assigned—Attorney Docket No. 20090374-US-NP) filed concurrently herewith, entitled UV Cured Intermediate Transfer Members, illustrates an intermediate transfer member comprised of a supporting substrate, and a mixture comprised of a conductive component, an epoxy acrylate, and a photoinitiator.

U.S. application No. (not yet assigned—Attorney Docket No. 20090442-US-NP) filed concurrently herewith, entitled Polymeric Intermediate Transfer Members, illustrates an intermediate transfer member comprised of a copolymer of a polyester, a polycarbonate, and a polyalkylene glycol.

U.S. application No. (not yet assigned—Attorney Docket No. 20090845-US-NP) filed concurrently herewith, entitled Silane Containing Intermediate Transfer Members, illustrates an intermediate transfer member comprised of a supporting substrate, a silane first intermediate layer, and contained on the silane layer a second layer of a self crosslinking acrylic resin; a mixture of a glycoluril resin and an acrylic polyol resin; or a mixture of a glycoluril resin and a self crosslinking acrylic resin.

Copending U.S. application Ser. No. 12/413,633 (Attorney Docket No. 20081272-US-NP) filed Mar. 30, 2009, entitled Fluorinated Sulfonic Acid Polymer Grafted Polyaniline Containing Intermediate Transfer Members, illustrates an intermediate transfer member comprised of a substrate, and in contact therewith a polyaniline having grafted thereto a fluorinated sulfonic acid polymer.

Copending U.S. application Ser. No. 12/413,638 (Attorney Docket No. 20081273-US-NP) filed Mar. 30, 2009, entitled Perfluoropolyether Polymer Grafted Polyaniline Containing Intermediate Transfer Members illustrates an intermediate transfer member comprised of a substrate and in contact with the substrate a polyaniline grafted perfluoropolyether phosphoric acid polymer.

Copending U.S. application Ser. No. 12/413,642 (Attorney Docket No. 20081274-US-NP) filed Mar. 30, 2009, entitled Fluorotelomer Grafted Polyaniline Containing Intermediate Transfer Members, the disclosure of which is totally incorporated herein by reference, illustrates an intermediate transfer member comprised of a substrate, and a layer comprised of polyaniline having grafted thereto a fluorotelomer.

Illustrated in U.S. application Ser. No. 12/129,995 (Attorney Docket No. 20080091-US-NP), filed May 30, 2008, entitled Polyimide Intermediate Transfer Components, is an intermediate transfer belt comprised of a substrate comprising a polyimide and a conductive component wherein the polyimide is cured at a temperature of from about 175° C. to about 290° C. over a period of time of from about 10 to about 120 minutes.

### BACKGROUND

Disclosed are intermediate transfer members, and more specifically, intermediate transfer members useful in transferring a developed image in an electrostatographic, for example xerographic, including digital, image on image, and the like, machines or apparatuses, and printers, inclusive of office and production printers. In embodiments, there are selected intermediate transfer members comprised of a phosphate ester, which is commercially available. In embodiments thereof, the phosphate ester is dispersed in or mixed with a suitable polymer, such as those illustrated herein, like a polyimide or a polycarbonate.

A number of advantages are associated with the intermediate transfer members, such as belts (ITB) of the present disclosure, which members include a phosphate ester which together with a polymeric binder forms a mixture which can be selected as a coating solution that can be readily mixed in both water and organic solvents; an excellent maintained member conductivity for extended time periods; ITB humidity insensitivity for extended time periods; excellent member dispersibility in a polymeric solution; wear and abrasion resistance; and low and acceptable surface friction characteristics for aiding in the transfer of developed xerographic images. More specifically, the phosphate ester intermediate transfer members, such as belts, disclosed enable, in embodiments thereof, the selection of a mixture of the phosphate ester and a polymeric binder rather than selecting a dispersion, and where the solution permits preparation ease and cost savings as compared to the use of a dispersion.

In a typical electrostatographic reproducing apparatus, a light image of an original to be duplicated is recorded in the form of an electrostatic latent image upon a photosensitive member, and the latent image is subsequently rendered visible by the application of electroscopic thermoplastic resin particles and colorant. Generally, the electrostatic latent image is developed by using a developer mixture, which usually comprises carrier granules having toner particles adhering triboelectrically thereto, or a liquid developer material, which may include a liquid carrier having toner particles dispersed therein. The developer material is advanced into contact with the electrostatic latent image, and the toner particles are deposited thereon in image configuration. Subsequently, the developed image is transferred to a substrate such as paper. It is advantageous to transfer the developed image to a coated intermediate transfer web, belt or component, and subsequently transfer with a high transfer efficiency the developed image from the intermediate transfer member to a permanent substrate. The transferred toner image is subsequently usually fixed or fused upon a support, which may be the photosensitive member itself, or other support sheet such as plain paper.

In electrostatographic printing machines wherein the toner image is electrostatically transferred by a potential difference between the imaging member and the intermediate transfer member, the transfer of the toner particles to the intermediate transfer member, and the retention thereof should be substantially complete so that the image ultimately transferred to the image receiving substrate will have a high resolution. Substantially about 100 percent toner transfer is desired when most or all of the toner particles comprising the image are transferred, and little residual toner remains on the surface from which the image was transferred.

In embodiments, it is desired to provide an intermediate transfer member, which has excellent transfer capabilities; is conductive, and more specifically, has excellent conductivity or resistivity as compared, for example, to an intermediate transfer member where a phosphate ester and a polymeric binder is absent; and possesses excellent humidity insensitivity characteristics leading to high developed image quality where developed images with minimal resolution issues can be obtained. It is also desired to provide a weldable intermediate transfer belt that may not, but could, have puzzle cut seams, and instead, has a weldable seam, thereby providing a belt that can be manufactured without labor intensive steps, such as manually piecing together the puzzle cut seam with fingers, and without the lengthy high temperature and high humidity conditioning steps. It is also desired to provide an intermediate transfer member, which has excellent wear and abrasion resistance, and more specifically, has excellent mechanical properties as compared, for example, to an intermediate transfer member where a phosphate ester and the polymeric binder are absent. Moreover, there is a need to provide intermediate transfer members where there can be selected for the preparation thereof a mixture or solution rather than a dispersion.

### REFERENCES

Illustrated in U.S. Pat. No. 7,031,647 is an imageable seamed belt containing a lignin sulfonic acid doped polyaniline.

Attempts at controlling the resistivity of intermediate transfer members by, for example, adding conductive fillers, such as ionic additives and/or carbon black to the outer layer, are disclosed in U.S. Pat. No. 6,397,034 which describes the use of a treated carbon filler in a polyimide intermediate transfer member layer. However, there can be problems associated with the use of such fillers in that undissolved particles frequently bloom or migrate to the surface of the fluorinated polymer and cause imperfections to the polymer, thereby causing nonuniform resistivity, which in turn causes poor antistatic properties and poor mechanical strength characteristics. Also, ionic additives on the ITB surface may interfere with toner release. Furthermore, bubbles may appear in the polymer, some of which can only be seen with the aid of a microscope, and others of which are large enough to be observed with the naked eye resulting in poor or nonuniform electrical properties and poor mechanical properties.

Illustrated in U.S. Pat. No. 7,139,519 is an intermediate transfer belt comprising a belt substrate comprising primarily at least one polyimide polymer, and a welded seam.

Illustrated in U.S. Pat. No. 7,130,569 is a weldable intermediate transfer belt comprising a substrate comprising a homogeneous composition comprising a polyaniline in an amount of, for example, from about 2 to about 25 percent by weight of total solids, and a thermoplastic polyimide present in an amount of from about 75 to about 98 percent by weight of total solids, wherein the polyaniline has a particle size of, for example, from about 0.5 to about 5 microns.

Puzzle cut seam members are disclosed in U.S. Pat. Nos. 5,487,707; 6,318,223, and 6,440,515.

Illustrated in U.S. Pat. No. 6,602,156 is a polyaniline filled polyimide puzzle cut seamed belt, however, the manufacture of a puzzle cut seamed belt is usually labor intensive and costly, and the puzzle cut seam, in embodiments, is sometimes weak. The manufacturing process for a puzzle cut seamed belt usually involves a lengthy in time high temperature and a high humidity conditioning step. For the conditioning step, each individual belt is rough cut, rolled up, and placed in a conditioning chamber that is environmentally controlled at about 45° C. and about 85 percent relative humidity for approximately 20 hours. To prevent or minimize condensation and watermarks, the puzzle cut seamed transfer belt resulting is permitted to remain in the conditioning chamber for a suitable period of time, such as 3 hours. The conditioning of the transfer belt renders it difficult to automate the manufacturing thereof, and the absence of such conditioning may adversely impact the belts electrical properties, which in turn results in poor image quality.

It is known that carbon can be used as the conductive particles in several intermediate transfer belts, however, carbon can be difficult to disperse. Also, it can be difficult to generate carbon black based ITBs with consistent resistivity because, for example, the loading thereof is present on the vertical part of the percolation curve and the working window for carbon black very narrow to achieve robust manufacturing process. In addition, in humid environments, moisture will tend to deposit on the ITB during idle and cause wrinkles induced transfer failures and print defects.

### SUMMARY

In embodiments, there is disclosed an intermediate transfer member comprised of a substrate comprising a phosphate ester and a polymeric component; an intermediate transfer member, such as an intermediate belt comprised of a supporting substrate such as a polyimide, and a layer thereover comprising a phosphate ester and a polymeric binder; an intermediate transfer member wherein the resisitivity thereof is from about 10⁸ to about 10¹³ ohm/square, from about 10⁹ to about 10¹² ohm/square, and more specifically, from about 10¹⁰ to about 10¹² ohm/square.

There is disclosed an intermediate transfer member comprised of a substrate comprising a phosphate ester or esters and a polymeric binder, and which member can, in embodiments, achieve an excellent maintained resistivity for extended time periods.

In embodiments, there is disclosed an intermediate transfer member comprised of a substrate comprising a phosphate ester and a polymer binder, and which member possesses excellent wear and abrasion resistance.

In addition, the present disclosure provides, in embodiments, an apparatus for forming images on a recording medium comprising a charge retentive surface that can receive an electrostatic latent image thereon; a development component to apply toner to the charge retentive surface to develop the electrostatic latent image and to form a developed image on the charge retentive surface; a weldable intermediate transfer belt member to transfer the developed image from the charge retentive surface to a substrate, and a fixing component, and where the member is comprised of the solution disclosed herein.

### DETAILED DESCRIPTION

Aspects of the present disclosure relate to an intermediate transfer member comprised of a phosphate ester, and a polymeric binder; an intermediate transfer member comprised of an optional supporting substrate, and a mixture of a phosphate ester and a polymeric binder, wherein the phosphate ester is an alkyl alcohol ethoxylate phosphate, an alkyl phenol ethoxylate phosphate, an alkyl polyethoxyethanol phosphate, an alkylphenoxy polyethoxyethanol phosphate, or mixtures thereof, and the polymeric binder is a polyimide, a polycarbonate, a polyamideimide, a polyphenylene sulfide, a polyamide, a polysulfone, a polyetherimide, a polyester, a polyvinylidene fluoride, a polyethylene-co-polytetrafluoroethylene, or mixtures thereof; an intermediate transfer belt comprised of a phosphate ester and a polymeric binder, wherein the phosphate ester is an alkyl alcohol ethoxylate phosphate, an alkyl phenol ethoxylate phosphate, an alkyl polyethoxyethanol phosphate, or an alkylphenoxy polyethoxyethanol phosphate, and the polymeric binder is a polyimide, a polycarbonate, a polyamideimide, a polyphenylene sulfide, a polyamide, a polysulfone, a polyetherimide, a polyester, a polyvinylidene fluoride, or a polyethylene-co-polytetrafluoroethylene, and where the ratio amount of the phosphate ester to the polymeric binder is between about 1/99 and about 40/60; an intermediate transfer member comprised of a solution mixture of a phosphate ester and a polymeric binder; a transfer media comprised of a phosphate ester, and a polymeric binder; and an apparatus for forming images on a recording medium comprising a charge retentive surface to receive an electrostatic latent image thereon; a development component to apply toner to the charge retentive surface to develop the electrostatic latent image, and to form a developed image on the charge retentive surface; an intermediate transfer member comprised of a solution mixture of a phosphate ester and a polymer where the ester is an alkyl alcohol alkoxylate phosphate, an alkyl phenol alkoxylate phosphate, an alkyl polyalkoxyethanol phosphate, an alkylphenoxy polyalkoxyethanol phosphate, or mixtures thereof, where said alkoxy contains from 1 to about 16 carbon atoms, and said alkyl contains from about 1 to about 36 carbon atoms, where the ratio of the ester to the binder is from about 5/95 to about 30/70, from about 10/90 to about 20/80, from about 5/95 or about 20/80, or about 5/95; and an intermediate transfer member comprised of a supporting substrate like a polymer, and a layer thereover comprising a mixture of a phosphate ester and a polymeric binder.

Examples of phosphate esters selected for the intermediate transfer member include a number of known phosphate esters, and more specifically, where the phosphate ester is a phosphate ester of alkyl alcohol ethoxylate, alkyl phenol ethoxylate, alkyl polyethoxyethanol, alkylphenoxy polyethoxyethanol, mixtures thereof, and corresponding alkoxy esters wherein alkyl and alkoxy contain, for example, from 1 to about 36 carbon atoms, from 1 to about 18 carbon atoms, from 1 to about 12 carbon atoms, from 1 to about 6 carbon atoms, optionally mixtures thereof, and the like.

Phosphate esters of alkyl alcohol ethoxylate examples include POLYSTEP® P-11, P-12 and P-13 (tridecyl alcohol ethoxylate phosphate, available from STEPAN Company, Northfield, Ill.) with an average mole number of ethoxy (EO) of about 3, 6 and 12, respectively. Examples of phosphate esters of alkyl phenol ethoxylates include POLYSTEP® P-31, P-32, P-33, P-34 and P-35 (nonylphenol ethoxylate phosphate, available from STEPAN Company, Northfield, Ill.) with an average mole number of ethoxy (EO) of about 4, 6, 8, 10 and 12, respectively. Examples of phosphate esters of alkyl polyethoxyethanol include STEPFAC™ 8180, 8181 and 8182 (polyethylene glycol monotridecyl ether phosphate, available from STEPAN Company, Northfield, Ill.) with an average mole number of ethoxy (EO) of about 3, 6 and 12, respectively. Examples of phosphate esters of alkylphenoxy polyethoxyethanol include STEPFAC™ 8170, 8171, 8172, 8173, 8175 (nonylphenol ethoxylate phosphate, available from STEPAN Company, Northfield, Ill.) with an average mole number of ethoxy (EO) of about 10, 6, 4, 8 and 12, respectively.

Various amounts of phosphate esters can be selected for the solution mixture, such as for example, from about 1 to about 40 weight percent, from 5 to about 30 weight percent, from 10 to about 20 weight percent, based on the percentage of components present in the solution mixture.

Examples of the polymeric binder that is mixed with the phosphate ester to generate a coating solution include polyimides, both thermosetting or thermoplastic polyimides; polycarbonates such as MAKROLON® 5705; polyamideimides; polyphenylene sulfides; polyamides; polysulfones; polyetherimides; polyethylene-co-polytetrafluoroethylenes; polyesters such as polybutylene terephthalate (PBT), polyethylene naphthalate (PEN) or a polyester copolymer; poly(vinylidene fluorides) (PVDF); and mixtures thereof.

Examples of rapidly cured polyimide polymers selected as the binder are, for example, VTEC™ PI 1388, 080-051, 851, 302, 203, 201 and PETI-5, all available from Richard Blaine International, Incorporated, Reading, Pa. These thermosetting polyimides are cured at suitable temperatures, and more specifically, from about 180° C. to about 260° C. over a short period of time, such as, for example, from about 10 to about 120 minutes, and from about 20 to about 60 minutes; possess, for example, a number average molecular weight of from about 5,000 to about 500,000, or from about 10,000 to about 100,000, and a weight average molecular weight of from about 50,000 to about 5,000,000, or from about 100,000 to about 1,000,000. Also, there can be selected as the binder thermosetting polyimide precursors that are usually cured at higher temperatures (above 300° C.) than the VTEC™ PI polyimide precursors, and which higher temperature cured precursors include, for example, PYRE-M.L® RC-5019. RC-5057, RC-5069, RC-5097, RC-5053, and RK-692, all commercially available from Industrial Summit Technology Corporation, Parlin, N.J.; RP-46 and RP-50, both commercially available from Unitech LLC, Hampton, Va.; DURIMIDE® 100 commercially available from FUJIFILM Electronic Materials U.S.A., Inc., North Kingstown, R.I.; and KAPTON® HN, VN and FN, commercially available from E.I. DuPont, Wilmington, Del.; and present, for example, in amounts of from about 60 to about 99, or from about 70 to about 90 weight percent of the intermediate transfer member components.

Also, polyimides that may be selected may be prepared as fully imidized polymers which do not contain any “amic” acid, and do not require high temperature cure to convert them to the imide form. A typical polyimide of this type may be prepared by reacting di-(2,3-dicarboxyphenyl)-ether dianhydride with 5-amino-1-(p-aminophenyl)-1,3,3-trimethylindene, which polymer is available as Polyimide XU 218 sold by Ciba-Geigy Corporation, Ardsley, N.Y. Other fully imidized polyimides are available from Lenzing Corporation in Dallas, Tex., and are sold as Lenzing P83 polyimide and by Mitsui Toatsu Chemicals, New York, N.Y. sold as Larc-TPI.

Examples of specific selected thermoplastic polyimide binders are KAPTON® KJ, commercially available from E.I. DuPont, Wilmington, Del., as represented by

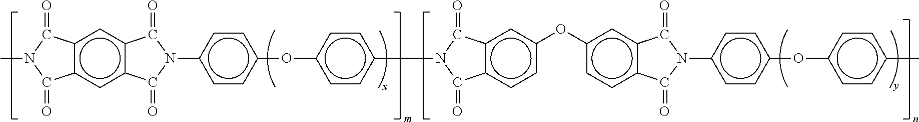

wherein x is equal to 2; y is equal to 2; m and n are from about 10 to about 300; and IMIDEX®, commercially available from West Lake Plastic Company, as represented by

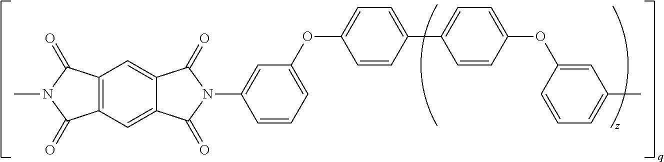

wherein z is equal to 1, and q is from about 10 to about 300.

Examples of polyamideimides that can be included in the intermediate transfer members are VYLOMAX® HR-11NN (15 weight percent solution in N-methylpyrrolidone, T_{g}=300° C., and M_{w}=45,000), HR-12N2 (30 weight percent solution in N-methylpyrrolidone/xylene/methyl ethyl ketone=50/35/15, T_{g}=255° C., and M_{w}=8,000), HR-13NX (30 weight percent solution in N-methylpyrrolidone/xylene=67/33, T_{g}=280° C., and M_{w}=10,000), HR-15ET (25 weight percent solution in ethanol/toluene=50/50, T_{g}=260° C., and M_{w}=10,000), HR-16NN (14 weight percent solution in N-methylpyrrolidone, T_{g}=320° C., and M_{w}=100,000), all commercially available from Toyobo Company of Japan, and TORLON®AI-10 (T_{g}=272° C.), commercially available from Solvay Advanced Polymers, LLC, Alpharetta, Ga.

Examples of polycarbonate binders selected include poly(4,4′-isopropylidene-diphenylene)carbonate (also referred to as bisphenol-A-polycarbonate), poly(4,4′-cyclohexylidine diphenylene)carbonate (also referred to as bisphenol-Z-polycarbonate), poly(4,4′-isopropylidene-3,3′-dimethyl-diphenyl) carbonate (also referred to as bisphenol-C-polycarbonate), and the like. In embodiments, the intermediate transfer member binders are comprised of bisphenol-A-polycarbonate resins, commercially available as MAKROLON®, with, for example, a weight average molecular weight of from about 50,000 to about 500,000.

Various amounts of the binder can be selected for the solution mixture, such as for example, from about 60 to about 99 weight percent, from about 70 to about 90 weight percent, from about 88 to about 99 weight percent, from about 84 to about 99 weight percent, and from about 85 to about 95 weight percent, based on the percentage of components present in the solution mixture.

The phosphate ester can be mixed together with a rapid curing thermosetting polyimide/N-methyl-2-pyrrolidone (NMP) solution, and then the mixture can be applied to or coated on a glass plate using known draw bar coating methods. The resulting film or films can be dried at high temperatures, such as from about 100° C. to about 400° C., from about 150° C. to about 300° C., or from about 175° C. to about 200° C. for a sufficient period of time, such as for example, from about 20 to about 180 minutes, or from about 75 to about 100 minutes while remaining on the glass plate. After drying and cooling to room temperature, the film or films on the glass plate or separate glass plates are immersed into water overnight, about 18 to 23 hours, and subsequently, the about 50 to about 150 microns thick film or films formed are released from the glass.

In embodiments, the phosphate ester can be mixed with a bisphenol-A-polycarbonate/methylene chloride (CH₂Cl₂) solution, and then the resulting solution mixture can be applied to or coated on a biaxially oriented poly(ethylene naphthalate) (PEN) substrate (KALEDEX™ 2000) having a known thickness of, for example, about 3.5 mils using known draw bar coating methods. The resulting film or films can be dried at high temperatures, such as from about 100° C. to about 200° C., or from about 120° C. to about 160° C. for a sufficient period of time, such as for example, from about 1 to about 30 minutes, or from about 5 to about 15 minutes while remaining on the PEN substrate. After drying and cooling to room temperature, about 23° C. to about 25° C., the film or films on the PEN substrate or separate PEN substrates are automatically released from the substrate resulting in the functional intermediate transfer member or members as disclosed herein.

The phosphate ester and polymeric binder solvents selected include, for example, alkylene halides such as methylene chloride, tetrahydrofuran, toluene, monochlorobenzene, N-methyl-2-pyrrolidone, N,N-dimethylformamide, N,N-dimethylacetamide, methyl ethyl ketone, methyl isobutyl ketone, mixtures thereof, and the like. Since both the phosphate ester and the polymeric binder are soluble, or substantially soluble in the solvent, a clear coating solution is obtainable. In contrast, when conductive species, such as carbon black, metal oxides or polyanilines, are selected, since they are insoluble in many solvents, they usually need to be dispersed. Dispersion preparation utilizes energy to break down the particles, and also many of the dispersions are not stable since the particle tends to aggregate.

Specific examples of supporting substrates include polyimides, polyamideimides, polyetherimides, and mixtures thereof.

More specifically, examples of the intermediate transfer member supporting substrates of a thickness, for example, of from 10 to about 300 microns, from 50 to about 150 microns, from 75 to about 125 microns, are polyimides inclusive of known low temperature, and rapidly cured polyimide polymers, such as VTEC™ PI 1388, 080-051, 851, 302, 203, 201, and PETI-5, all available from Richard Blaine International, Incorporated, Reading, Pa. These thermosetting polyimides can be cured at temperatures of from about 180° C. to about 260° C. over a short period of time, such as from about 10 to about 120 minutes, or from about 20 to about 60 minutes; possess a number average molecular weight of from about 5,000 to about 500,000, or from about 10,000 to about 100,000, and a weight average molecular weight of from about 50,000 to about 5,000,000, or from about 100,000 to about 1,000,000. Also, for the supporting substrate there can be selected thermosetting polyimides that can cured at temperatures of above 300° C., such as PYRE M.L.® RC-5019, RC 5057, RC-5069, RC-5097, RC-5053, and RK-692, all commercially available from Industrial Summit Technology Corporation, Parlin, N.J.; RP-46 and RP-50, both commercially available from Unitech LLC, Hampton, Va.; DURIMIDE® 100, commercially available from FUJIFILM Electronic Materials U.S.A., Inc., North Kingstown, R.I.; and KAPTON® HN, VN and FN, all commercially available from E.I. DuPont, Wilmington, Del.

Examples of polyamideimides that can be selected as supporting substrates are VYLOMAX® HR-11NN (15 weight percent solution in N-methylpyrrolidone, T_{g}=300° C., and M_{w}=45,000), HR-12N2 (30 weight percent solution in N-methylpyrrolidone/xylene/methyl ethyl ketone=50/35/15, T_{g}=255° C., and M_{w}=8,000), HR-13NX (30 weight percent solution in N-methylpyrrolidone/xylene=67/33, T_{g}=280° C., and M_{w}=10,000), HR-15ET (25 weight percent solution in ethanol/toluene=50/50, T_{g}=260° C., and M_{w}=10,000), HR-16NN (14 weight percent solution in N-methylpyrrolidone, T_{g}=320° C., and M_{w}=100,000), all commercially available from Toyobo Company of Japan, and TORLON® AI-10 (T_{g}=272° C.), commercially available from Solvay Advanced Polymers, LLC, Alpharetta, Ga.

The disclosed intermediate transfer members are, in embodiments, weldable, that is the seam of the member like a belt is weldable, and more specifically, may be ultrasonically welded to produce a seam. The surface resistivity of the disclosed intermediate transfer member is, for example, from about 10⁹ to about 10¹³ ohm/square, or from about 10¹⁰ to about 10¹² ohm/square. The sheet resistivity of the intermediate transfer weldable member is, for example, from about 10⁹ to about 10¹³ ohm/square, or from about 10¹⁰ to about 10¹² ohm/square.

The intermediate transfer members illustrated herein like intermediate transfer belts can be selected for a number of printing and copying systems, inclusive of xerographic printing. For example, the disclosed intermediate transfer members can be incorporated into a multi-imaging system where each image being transferred is formed on the imaging or photoconductive drum at an image forming station, wherein each of these images is then developed at a developing station, and transferred to the intermediate transfer member. The images may be formed on the photoconductor and developed sequentially, and then transferred to the intermediate transfer member. In an alternative method, each image may be formed on the photoconductor or photoreceptor drum, developed, and transferred in registration to the intermediate transfer member. In an embodiment, the multi-image system is a color copying system, wherein each color of an image being copied is formed on the photoreceptor drum, developed, and transferred to the intermediate transfer member.

After the toner latent image has been transferred from the photoreceptor drum to the intermediate transfer member, the intermediate transfer member may be contacted under heat and pressure with an image receiving substrate such as paper. The toner image on the intermediate transfer member is then transferred and fixed, in image configuration, to the substrate such as paper.

The intermediate transfer member present in the imaging systems illustrated herein, and other known imaging and printing systems may be in the configuration of a sheet, a web, a belt, including an endless belt, and an endless seamed flexible belt; a roller, a film, a foil, a strip, a coil, a cylinder, a drum, an endless strip, and a circular disc. The intermediate transfer member can be comprised of a single layer, or can be comprised of several layers, such as from about 2 to about 5 layers. In embodiments, the intermediate transfer member further includes an outer release layer.

Release layer examples situated on and in contact with the phosphate ester polymeric binder layer include low surface energy materials, such as TEFLON®-like materials including fluorinated ethylene propylene copolymer (FEP), polytetrafluoroethylene (PTFE), polyfluoroalkoxy polytetrafluoroethylene (PFA TEFLON®), and other TEFLON®-like materials; silicone materials, such as fluorosilicones and silicone rubbers, such as Silicone Rubber 552, available from Sampson Coatings, Richmond, Va., (polydimethyl siloxane/dibutyl tin diacetate, 0.45 gram DBTDA per 100 grams polydimethyl siloxane rubber mixture, with a molecular weight M_{w} of approximately 3,500); and fluoroelastomers, such as those sold as VITON®, such as copolymers and terpolymers of vinylidenefluoride, hexafluoropropylene, and tetrafluoroethylene, which are known commercially under various designations as VITON A®, VITON E®, VITON E60C®, VITON E45®, VITON E430®, VITON B910®, VITON GH®, VITON B50®, VITON E45®, and VITON GF®. The VITON® designation is a Trademark of E.I. DuPont de Nemours, Inc. Two known fluoroelastomers are comprised of (1) a class of copolymers of vinylidenefluoride, hexafluoropropylene, and tetrafluoroethylene, known commercially as VITON A®; (2) a class of terpolymers of vinylidenefluoride, hexafluoropropylene, and tetrafluoroethylene, known commercially as VITON B®; and (3) a class of tetrapolymers of vinylidenefluoride, hexafluoropropylene, tetrafluoroethylene, and a cure site monomer, such as VITON GF®, having 35 mole percent of vinylidenefluoride, 34 mole percent of hexafluoropropylene, and 29 mole percent of tetrafluoroethylene with 2 percent cure site monomer. The cure site monomer can be those available from E.I. DuPont de Nemours, Inc. such as 4-bromoperfluorobutene-1,1,1-dihydro-4-bromoperfluorobutene-1,3-bromoperfluoropropene-1,1,1-dihydro-3-bromoperfluoropropene-1, or any other suitable, known, commercially available cure site monomers.

The release layer or layers may be deposited on the layer of the phosphate ester polymeric binder mixture by well known coating processes. Known methods for forming the outer layer(s) on the substrate film, such as dipping, spraying such as by multiple spray applications of very thin films, casting, flow-coating, web-coating, roll-coating, extrusion, molding, or the like, can be used. Usually it is desirable to deposit the layers by spraying such as by multiple spray applications of very thin films, casting, by web coating, by flow-coating, and more specifically, by laminating.

The circumference of the intermediate transfer member, especially as it is applicable to a film or a belt configuration, is, for example, from about 250 to about 2,500 millimeters, from about 1,500 to about 2,500 millimeters, or from about 2,000 to about 2,200 millimeters with a corresponding width of, for example, from about 100 to about 1,000 millimeters, from about 200 to about 500 millimeters, or from about 300 to about 400 millimeters.

Specific embodiments will now be described in detail. These examples are intended to be illustrative, and are not limited to the materials, conditions, or process parameters set forth in these embodiments. All parts are percentages by weight of total solids unless otherwise indicated.

### Example I

The phosphate esters, 5 weight percent, STEPFAC® 8180 (a polyethylene glycol monotridecyl ether phosphate); STEPFAC® 8170 (a nonylphenol ethoxylate phosphate); POLYSTEP® P-13 (a tridecyl alcohol ethoxylate phosphate), and POLYSTEP® P-34 (a nonylphenol ethoxylate phosphate with an average mole number of ethoxy (EO) of about 4, 6, 8, 10 and 12, all commercially available from STEPAN Company, Northfield, Ill., were individually mixed with a polymeric binder of 95 weight percent of the polycarbonate MAKROLON® 5705, having a molecular weight average, as determined by Gel Permeation Chromatography (GPC), of from about 50,000 to about 100,000, commercially available from Farbenfabriken Bayer A.G., in methylene chloride with a solid content of about 10 weight percent. By mixing for about 6 hours, four clear coating solutions were obtained. Each coating solution was then coated on a biaxially oriented poly(ethylene naphthalate) (PEN) substrate (KALEDEX™ 2000) having a thickness of 3.5 mils using known draw bar coating methods. The resulting films were dried at about 120° C. for 20 minutes while remaining on the PEN substrate. After drying and cooling to room temperature, the films on the PEN substrates were automatically released, with no assistance from external sources, from the substrate resulting in four 75 micron thick intermediate transfer members of a phosphate ester/polycarbonate with a ratio by weight of 5/95.

### Surface Resistivity Measurement

The above ITB members or devices of Example I were measured for surface resistivity (averaging four to six measurements at varying spots, 72° F./50 percent room humidity) using a High Resistivity Meter (Hiresta-Up MCP-HT450 from Mitsubishi Chemical Corp.). The results are provided in Table 1.

TABLE 1

| | Surface Resistivity |
|---|---|
| Example I Intermediate Transfer Members | (ohm/square) |
| STEPFAC ® 8180/MAKROLON ® 5705 = 5/95 | 7.6 × 10¹⁰ |
| STEPFAC ® 8170/MAKROLON ® 5705 = 5/95 | 7.7 × 10¹⁰ |
| POLYSTEP ® P-13/MAKROLON ® 5705 = 5/95 | 1.7 × 10¹² |
| POLYSTEP ® P-34/MAKROLON ® 5705 = 5/95 | 1.0 × 10¹¹ |

Thus, intermediate transfer members were obtained with a surface resistivity of from about 10¹⁰ to about 10¹² ohm/square when 5 weight percent of the above conductive phosphate esters were incorporated into the polycarbonate binder. The four coating solution preparations were prepared by simply mixing the phosphate ester and the polycarbonate binder. In contrast, conductive components, such as carbon black, polyaniline, and metal oxide, usually require the preparation of dispersions, and with additional energy, such as mechanical shearing, to break down the component into smaller sizes. With the Example I members, homogeneous coating solutions were obtained, rather than dispersions.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. An intermediate transfer member comprised of a phosphate ester, and a polymeric binder.

2. An intermediate transfer member in accordance with claim 1 wherein said phosphate ester is an alkyl alcohol alkoxylate phosphate, an alkyl phenol alkoxylate phosphate, an alkyl polyalkoxyyethanol phosphate, an alkylphenoxy polyalkoxyethanol phosphate, or mixtures thereof, where said alkoxy contains from 1 to about 16 carbon atoms, and said alkyl contains from about 1 to about 36 carbon atoms.

3. An intermediate transfer member in accordance with claim 1 wherein said phosphate ester is an alkyl alcohol ethoxylate phosphate, an alkyl phenol ethoxylate phosphate, an alkyl polyethoxyethanol phosphate, an alkylphenoxy polyethoxyethanol phosphate, or mixtures thereof.

4. An intermediate transfer member in accordance with claim 1 wherein said phosphate ester is a tridecyl alcohol ethoxylate phosphate, a polyethylene glycol monotridecyl ether phosphate, or a nonylphenol ethoxylate phosphate.

5. An intermediate transfer member in accordance with claim 1 wherein alkyl contains from 1 to about 24 carbon atoms.

6. An intermediate transfer member in accordance with claim 1 wherein alkyl contains from 1 to about 12 carbon atoms.

7. An intermediate transfer member in accordance with claim 1 wherein said phosphate ester possesses an ethoxy (EO) mole number, as measured by NMR nuclear magnetic resonance, of from about 1 to about 40.

8. An intermediate transfer member in accordance with claim 1 wherein said phosphate ester possesses an ethoxy (EO) mole number, as measured by NMR nuclear magnetic resonance, of from about 2 to about 20.

9. An intermediate transfer member in accordance with claim 1 wherein said phosphate ester is present in an amount of from about 1 to about 40 weight percent of the member components.

10. An intermediate transfer member in accordance with claim 1 wherein said phosphate ester is present in an amount of from about 5 to about 30 weight percent of the member components.

11. An intermediate transfer member in accordance with claim 1 wherein said member is a weldable belt.

12. An intermediate transfer member in accordance with claim 1 wherein said polymeric binder is a polyimide, a polycarbonate, a polyamideimide, a polyphenylene sulfide, a polyamide, a polysulfone, a polyetherimide, a polyester, a polyvinylidene fluoride, a polyethylene-co-polytetrafluoroethylene, or mixtures thereof.

13. An intermediate transfer member in accordance with claim 1 wherein said phosphate ester is mixed with said polymeric binder of at least one of a polyimide, a polycarbonate, a polyester, a poly(butylene terephthalate), a poly(ethylene terephthalate), a poly(ethylene naphthalate), a polyvinylidene fluoride, a polysulfone, a polyetherimide, a polyamideimide, or a polyethylene-co-polytetrafluoroethylene, and a solvent selected from methylene chloride, tetrahydrofuran, toluene, monochlorobenzene, N-methyl-2-pyrrolidone, N,N-dimethylformamide, N,N-dimethylacetamide, methyl ethyl ketone, or methyl isobutyl ketone, thereby forming a solution thereof.

14. An intermediate transfer member in accordance with claim 1 wherein said member has a surface resistivity of from about 10⁸ to about 10¹³ ohm/square.

15. An intermediate transfer member in accordance with claim 1 wherein said member has a surface resistivity of from about 10¹⁰ to about 10¹² ohm/square.

16. An intermediate transfer member in accordance with claim 1 further comprising an outer release layer positioned on said member.

17. An intermediate transfer member in accordance with claim 16 wherein said release layer comprises a fluorinated ethylene propylene copolymer, a polytetrafluoroethylene, a polyfluoroalkoxy polytetrafluoroethylene, a fluorosilicone, a terpolymer of vinylidene fluoride, hexafluoropropylene, and tetrafluoroethylene, or mixtures thereof.

18. An intermediate transfer member comprised of an optional supporting substrate, and a mixture of a phosphate ester and a polymeric binder, wherein said phosphate ester is an alkyl alcohol ethoxylate phosphate, an alkyl phenol ethoxylate phosphate, an alkyl polyethoxyethanol phosphate, an alkylphenoxy polyethoxyethanol phosphate, or mixtures thereof; and said polymeric binder is a polyimide, a polycarbonate, a polyamideimide, a polyphenylene sulfide, a polyamide, a polysulfone, a polyetherimide, a polyester, a polyvinylidene fluoride, a polyethylene-co-polytetrafluoroethylene, or mixtures thereof.

19. An intermediate transfer belt comprised of an optional supporting substrate and a mixture of a phosphate ester and a polymeric binder, wherein said phosphate ester is an alkyl alcohol ethoxylate phosphate, an alkyl phenol ethoxylate phosphate, an alkyl polyethoxyethanol phosphate, or an alkylphenoxy polyethoxyethanol phosphate; said polymeric binder is a polyimide, a polycarbonate, a polyamideimide, a polyphenylene sulfide, a polyamide, a polysulfone, a polyetherimide, a polyester, a polyvinylidene fluoride, or a polyethylene-co-polytetrafluoroethylene; and wherein the ratio of said phosphate ester to said polymeric binder is between about 1/99 and about 40/60.

20. An intermediate transfer belt in accordance with claim 19 wherein said ratio is from about 5/95 to about 30/70.

21. An intermediate transfer belt in accordance with claim 19 wherein said ratio is from about 10/90 to about 20/80.

22. An intermediate transfer belt in accordance with claim 19 wherein said phosphate ester and said polymeric binder are mixed to form a solution thereof, and wherein said supporting substrate is present and is a polyimide, a polyamideimide, or a polyetherimide, and wherein said phosphate ester is conductive, and said belt optionally possesses a surface resistivity of from about 10⁹ to about 10¹² ohm/square.

23. An intermediate transfer belt in accordance with claim 22 wherein said ratio of said phosphate ester to said polymeric binder is about 5/95.

24. An intermediate transfer belt in accordance with claim 19 wherein said ratio of said phosphate ester to said polymeric binder is 20/80.

25. An intermediate transfer belt in accordance with claim 19 wherein said phosphate ester and said polymeric binder are mixed to form a solution thereof when mixed with an alkylene halide solvent, and wherein said supporting substrate is present and is a polyimide, a polyamideimide, or a polyetherimide, and wherein said phosphate ester is conductive, and said belt possesses a surface resistivity of from about 10⁹ to about 10¹² ohm/square.

26. An intermediate transfer belt in accordance with claim 1 wherein said phosphate ester and said polymeric binder are mixed with an alkylene halide solvent to form a solution.

27. An intermediate transfer belt in accordance with claim 1 wherein said phosphate ester and said polymeric binder are mixed with a methylene chloride solvent to form a solution thereof.

28. An intermediate transfer belt in accordance with claim 2 wherein said alkoxy is methoxy, ethoxy, propoxy, butoxy, or pentoxy, and said alkyl is methyl, ethyl, propyl, butyl, or pentyl.

29. An intermediate transfer member in accordance with claim 1 wherein said phosphate ester is a nonylphenol ethoxylate phosphate.

30. An intermediate transfer member in accordance with claim 1 wherein said phosphate ester is a tridecyl alcohol ethoxylate phosphate.

31. An intermediate transfer member in accordance with claim 1 wherein said phosphate ester is a nonylphenol ethoxylate phosphate with an average mole number of ethoxy (EO) of about 4, 6, 8, 10 and 12.

32. An intermediate transfer member in accordance with claim 1 wherein said phosphate ester is a polyethylene glycol monotridecyl ether phosphate.

33. An intermediate transfer member in accordance with claim 1 wherein said phosphate ester is a polyethylene glycol monotridecyl ether phosphate; a nonylphenol ethoxylate phosphate, or a tridecyl alcohol ethoxylate phosphate, and said polymeric binder is a polycarbonate.
